(19) United States
(12) Patent Application Publication
(10) Pub. No.: US 2012/0288209 A1
(43) Pub. Date: Nov. 15, 2012

(54) IMAGE PROCESSING APPARATUS AND IMAGE PROCESSING METHOD

(75) Inventors: Takeshi MIYAI, Kanagawa (JP); Masashi Uchida, Tokyo (JP)

(73) Assignee: Sony Corporation, Tokyo (JP)

(21) Appl. No.: 13/449,765

(22) Filed: Apr. 18, 2012

(30) Foreign Application Priority Data
May 9, 2011 (JP) 2011-104035

(51) Int. Cl. G06K 9/36

(52) U.S. Cl. 382/233

(57) ABSTRACT

There is provided an image processing apparatus including: an encoding processing unit carrying out a compression encoding process on input image data to obtain encoded data; an additional information generating unit generating, based on additional information generating information relating to the input image data, additional information to be used when specified image processing is carried out on image data obtained by carrying out a compression decoding process on the encoded data; and a data output unit outputting the encoded data obtained by the encoding processing unit and the additional information generated by the additional information generating unit in association with one another.

### BACKGROUND

The present disclosure relates to an image processing apparatus and an image processing method. In more detail, the present disclosure relates to an image processing apparatus or the like that obtains encoded data by carrying out a compression encoding process, such as a predictive encoding technique, on image data.

In the past, when an image quality enhancing process was carried out after the encoding and decoding of input image data, such encoding and decoding processes and the image quality enhancing process were carried out independently, with only image data being passed from the decoding process to the image quality enhancing process. This results in the problem of the encoding and decoding processes adversely affecting the image quality enhancing process.

As one example, when the encoding and decoding processes have caused deterioration in the image, in some cases the deterioration will be emphasized by the image quality enhancing process. In such cases, it is necessary to weaken the overall effect of the image quality enhancing process so as to prevent the deterioration from being emphasized or to lower the compression ratio to reduce the deterioration caused in the encoding and decoding processes, or in other words, to increase the transfer rate. Also, when the characteristics of the spatio-temporal resolution of an image have been greatly changed by the encoding and decoding processes, there are cases where the image quality enhancing process cannot achieve a sufficient effect.

For example, Japanese Laid-Open Patent Publication No. 2001-285881 attempts to solve this problem by using decoding process additional information referred to in the decoding process in the subsequent image quality enhancing process. However, there is no guarantee that the decoding process additional information will include information that will be useful for such purpose, resulting in the problem that there will be no effect when useful information is not included.

### SUMMARY

The present disclosure aims to favorably carry out image processing, such as an image quality enhancing process, on image data that has been subjected to encoding and decoding.

According to an embodiment of the present disclosure, there is provided an image processing apparatus including an encoding processing unit carrying out a compression encoding process on input image data to obtain encoded data, an additional information generating unit generating, based on additional information generating information relating to the input image data, additional information to be used when specified image processing is carried out on image data obtained by carrying out a compression decoding process on the encoded data, and a data output unit outputting the encoded data obtained by the encoding processing unit and the additional information generated by the additional information generating unit in association with one another.

According to the present disclosure, a compression encoding process is carried out on the input image data by the encoding processing unit to obtain encoded data. Additional information is also generated by the additional information generating unit based on additional information generating information relating to the input image data. This additional information is used when carrying out specified image processing on image data obtained by carrying out a compression decoding process on the encoded data. The encoded data obtained by the encoding processing unit and the additional information generated by the additional information generating unit are then outputted in association with one another by the data output unit. As one example, mixed data where the additional information has been mixed into the encoded data is outputted.

According to the present disclosure, the additional information used in image processing on the image data that has undergone encoding and decoding is transferred together with the encoded data. This means that during the image processing on image data that has undergone encoding and decoding, it is possible to carry out favorable processing using the additional information.

The specified image processing carried out on the image data obtained by carrying out the compression decoding process on the encoded data may be an image quality enhancing process, and the additional information generated by the additional information generating unit may be information used when carrying out the image quality enhancing process.

As examples, the image quality enhancing process is a sharpening process or a contrast correction process, and the additional information generating unit generates, as the additional information, information showing whether high-frequency information has been lost or tone information has been lost due to the compression encoding process. In this case, as one example, the additional information generating unit may generate, as the additional information, information relating to a difference between spatial activity of the input image data and spatial activity of the image data obtained by carrying out the compression decoding process on the encoded data.

In this case, when the additional information shows that high-frequency information has been lost due to the compression encoding process, a sharpening process is carried out as the image quality enhancing process, and when the additional information shows that tone information has been lost due to the compression encoding process, a contrast correction process (smoothing process) is carried out as the image quality enhancing process. By using the additional information, a sharpening process or a contrast correction process is favorably carried out on the image data that has undergone encoding and decoding.

As another example, the image quality enhancing process is a noise reduction process, and the additional information generating unit generates, as the additional information, information showing a size of deterioration (noise) produced in the compression encoding process. In this case, the additional information generating unit generates, as the additional information, information on a maximum value of an absolute difference between the input image data and image data obtained by carrying out a compression decoding process on the encoded data. In this case, by using the additional information, the noise reduction process is favorably carried out on the image data that has undergone encoding and decoding.

In the present disclosure, for example, the specified image processing carried out on the image data obtained by carrying out the compression decoding process on the encoded data may be an image enlargement process that enlarges a region of a specified object, and the additional information generated by the additional information generating unit may be region information of the specified object obtained by carrying out a detection process for the specified object based on the input image data. By using the additional information, an image enlargement process that enlarges a specified object region such as faces is favorably carried out on the image data that has undergone encoding and decoding.

According to another embodiment of the present disclosure, there is provided an image processing apparatus including a separating unit separating, from mixed data in which encoded data and additional information to be used when carrying out specified image processing on image data obtained by carrying out a compression decoding process on the encoded data are mixed, the encoded data and the additional information, a decoding processing unit carrying out the compression decoding process on the encoded data separated by the separating unit to obtain the image data, and an image processing unit carrying out the specified image processing on the image data obtained by the decoding processing unit using the additional information separated by the separating unit to obtain output image data.

According to the present disclosure, the encoded data and the additional information are separated from the mixed data by a separating unit. Here, the additional information is information to be used when carrying out specified image processing on image data obtained by carrying out a compression decoding process on the encoded data. The specified image processing is an image quality enhancing process (a sharpening process, a contrast correction process, or a noise reduction process), a face region enlargement process, or the like. A compression decoding process is carried out on the encoded data by a decoding processing unit to obtain the image data. Specified image processing is then favorably carried out on the image data by an image processing unit using the additional information.

According to the present disclosure, it is possible to favorably carry out image processing, such as an image quality enhancing process, on image data that has undergone encoding and decoding.

### BRIEF DESCRIPTION OF THE DRAWINGS

FIG. 1 is a block diagram showing an example configuration of an image transfer system according to a first embodiment of the present disclosure;

FIGS. 2A and 2B are diagrams useful in explaining examples where the image quality enhancing process is a sharpening process and a contrast correction process;

FIG. 3 is a block diagram showing an example configuration of an additional information generating unit that constructs an image processing apparatus on a transmitter side;

FIG. 4 is a diagram useful in explaining a calculation operation for activity by an activity calculating unit;

FIG. 5 is a block diagram showing an example configuration of an image quality enhancing processing unit that constructs an image processing apparatus on a receiver side;

FIGS. 6A and 6B are diagrams showing example patterns of a class tap and a prediction tap in class-classification adaptive processing;

FIG. 7 is a block diagram showing an example configuration of a generation apparatus that generates a prediction coefficient set to be used in class-classification adaptive processing;

FIG. 8 is a block diagram showing an example configuration of the image quality enhancing processing unit that constructs the image processing apparatus on the receiver side;

FIG. 9 is a block diagram showing another example configuration of the image quality enhancing processing unit that constructs the image processing apparatus on the receiver side;

FIG. 10 is a diagram useful in explaining a case where the image quality enhancing process is a noise reduction process;

FIG. 11 is a block diagram showing another example configuration of the additional information generating unit that constructs the image processing apparatus on the transmitter side;

FIG. 12 is a block diagram showing another example configuration of the image quality enhancing processing unit that constructs the image processing apparatus on the receiver side; and

FIG. 13 is a block diagram showing an example configuration of an image transfer system according to a second embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The embodiments of the present disclosure are described in the order indicated below.
1. First Embodiment
2. Second Embodiment
3. Modifications

### 1. First Embodiment

### Configuration of Image Transfer System

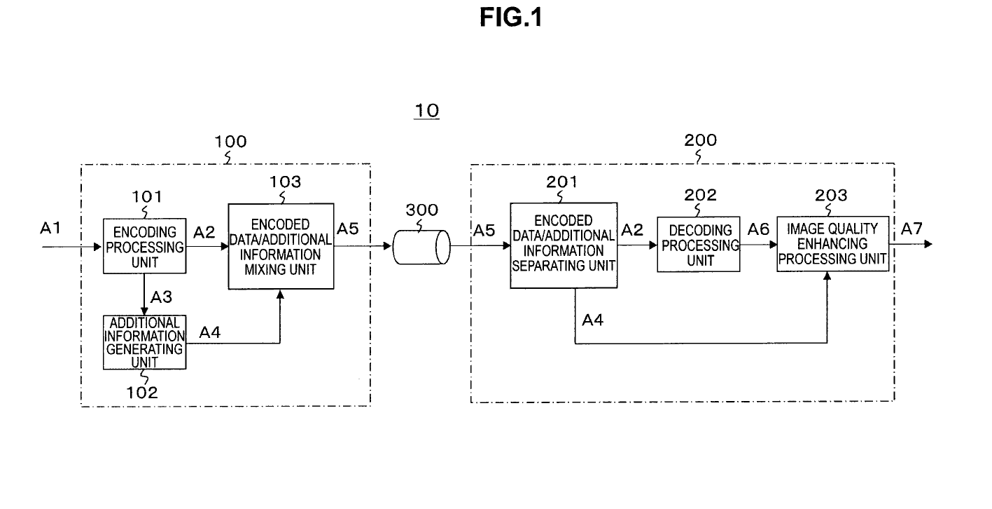

FIG. 1 shows an example configuration of an image transfer system 10 as a first embodiment of the present disclosure. The image transfer system 10 is configured by connecting an image processing apparatus 100 on a transmitter side (recording side) and an image processing apparatus 200 on a receiver side (reproduction side) via a transfer path 300. The expression “transfer path 300” includes a communication path, such as a network, and a recording/reproduction unit, such as a recording medium like an optical disc or a memory.

The image processing apparatus 100 includes an encoding processing unit 101, an additional information generating unit 102, and an encoded data/additional information mixing unit 103. The encoded data/additional information mixing unit 103 constructs a “data output unit” for the present disclosure. The encoding processing unit 101 carries out a compression encoding process according to an encoding technique such as MPEG2 on input image data A1 to obtain encoded data A2. The encoded data A2 includes accompanying information (decoding additional information) that is required for a decoding process.

The following describes examples of the decoding additional information.
(1) Signal type information, such as the components in a component signal (Y, U, V components, Y, Pr, Pb components, R, G, B components, or the like)
(2) Image format information, such as interlaced/progressive identification information, a field or frame frequency (temporal resolution information), image size information showing the horizontal resolution and the number of vertical lines (spatial resolution information), and aspect ratio information such as 4:3 or 16:9
(3) Image quality information such as transfer bitrate (compression rate) information
(4) Motion vectors, such as information showing horizontal and vertical movement

Based on additional information generating information A3 related to the input image data A1, the additional information generating unit 102 generates useful additional information A4 to be used in an image quality enhancing process that will be performed at the receiver side on image data obtained by carrying out a compression decoding process on the encoded data A2. The additional information generating information A3 may be the input image data A1, the encoded data A2, or the like. The additional information A4 is also completely different to the decoding additional information described earlier.

The encoded data/additional information mixing unit 103 mixes the additional information A4 generated by the additional information generating unit 102 into the encoded data A2 obtained by the encoding processing unit 101 to obtain mixed data A5. The mixed data A5 constructs the “transfer data” and is sent via the transfer path 300 to the image processing apparatus 200 on the receiver side. The additional information A4 generated by the additional information generating unit 102 will be described in detail later.

The image processing apparatus 200 includes an encoded data/additional information separating unit 201, a decoding processing unit 202, and an image quality enhancing processing unit 203. The encoded data/additional information separating unit 201 separates the encoded data A2 and the additional information A4 from the mixed data A5. The decoding processing unit 202 subjects the encoded data A2 separated by the encoded data/additional information separating unit 201 to a compression decoding process to obtain image data A6.

The image quality enhancing processing unit 203 carries out an image quality enhancing process on the image data A6 obtained by the decoding processing unit 202 using the additional information A4 separated by the encoded data/additional information separating unit 201 and outputs output image data A7. The image quality enhancing process is processing that raises the quality of the images and as examples may include a sharpening process, a contrast correction process, a noise reduction process, a spatial resolution increasing process, and a temporal resolution increasing process. The image quality enhancing unit 203 will be described in detail later in this specification.

The operation of the image transfer system 10 shown in FIG. 1 will now be described in brief. First, the operation of the image processing apparatus 100 on the transmitter side will be described. The input image data A1 is supplied to the encoding processing unit 101. In the encoding processing unit 101, a compression encoding process is carried out according to an encoding technique such as MPEG2 on the input image data A1 to obtain the encoded data A2. This encoded data A2 is supplied to the encoded data/additional information mixing unit 103.

The additional information generating information A3 relating to the input image data A1, for example, the input image data A1, the encoded data A2, or the like, is supplied from the encoding processing unit 101 to the additional information generating unit 102. The additional information generating unit 102 generates, based on the additional information generating information A3, useful additional information A4, which will be used when the image quality enhancing process is carried out at the receiver side on image data obtained by carrying out a compression decoding process on the encoded data A2. The additional information A4 is supplied to the encoded data/additional information mixing unit 103.

In the encoded data/additional information mixing unit 103, mixed data A5 where the additional information A4 is mixed into the encoded data A2 is obtained. The mixed data A5 is sent via the transfer path 300 to the image processing apparatus 200 on the receiver side.

Next, the operation of the image processing apparatus 200 on the receiver side will be described. The mixed data A5 is supplied to the encoded data/additional information separating unit 201. In the encoded data/additional information separating unit 201, the encoded data A2 and the additional information A4 are separated from the mixed data A5. The encoded data A2 is supplied to the decoding processing unit 202. The additional information A4 is supplied to the image quality enhancing processing unit 203.

In the decoding processing unit 202, a compression decoding process is carried out on the encoded data A2 to obtain the image data A6. At this time, the decoding processing unit 202 uses the decoding additional information included in the encoded data A2. The image data A6 is supplied to the image quality enhancing processing unit 203. In the image quality enhancing processing unit 203, using the additional information A4 separated by the encoded data/additional information separating unit 201, an image quality enhancing process, such as a sharpening process, a contrast correction process, or a noise reduction process, is carried out on the image data A6 obtained by the decoding processing unit 202. After this, the image data produced by the image quality enhancing process is outputted from the image quality enhancing processing unit 203 as the output image data A7.

### Detailed Description of Image Quality Enhancing Process and Additional Information

The image quality enhancing process carried out by the image quality enhancing processing unit 203 and the additional information A4 generated by the additional information generating unit 102 will now be described in detail.

### (1) When Image Quality Enhancing Process is a Sharpening Process or a Contrast Correction Process

First, a case where the image quality enhancing process is a sharpening process or a contrast correction process will be described.

Although it is typical for image information to be lost when a compression encoding process is carried out, the processing of the image quality enhancing process will differ depending on what information has been lost. Since it is not possible to know from the decoded image data itself what information has been lost, during decoding it is not possible to recreate such information.

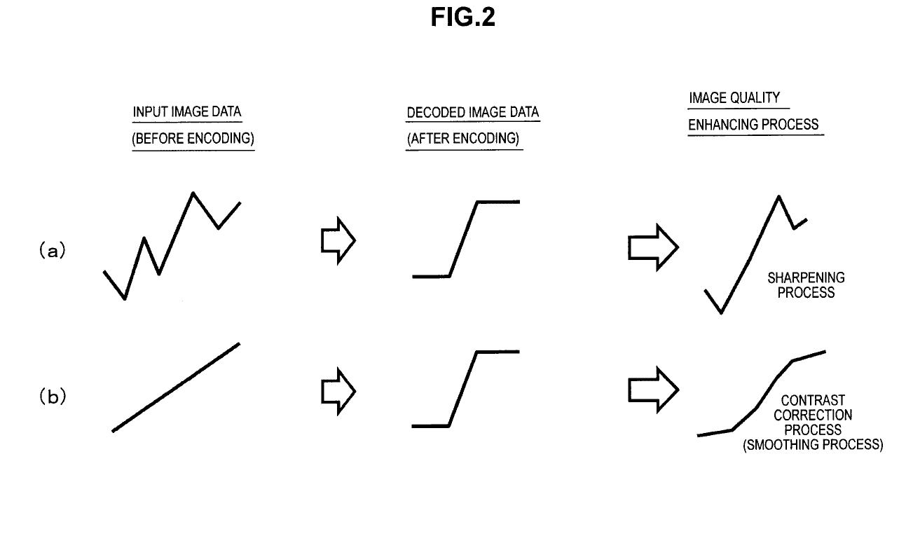

For example, as shown in FIG. 2A, if the decoding image data is data where high frequency information has been lost from the input image data, it is desirable to carry out a sharpening process as the image quality enhancing process. As another example, as shown in FIG. 2B, if the decoding image data is data where tone information has been lost from the input image data, it is desirable to carry out a contrast correction process (smoothing process) as the image quality enhancing process.

In this case, the additional information A4 generated by the additional information generating unit 102 in the image processing apparatus 100 on the transmitter side is information showing whether high frequency information has been lost or whether tone information has been lost due to the compression encoding process.

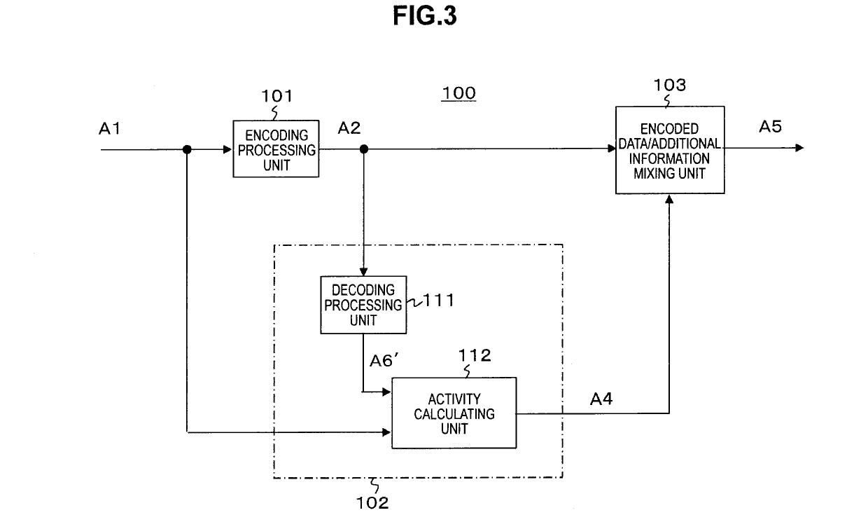

FIG. 3 shows an example configuration of the additional information generating unit 102. The additional information generating unit 102 includes a decoding processing unit 111 and an activity calculating unit 112. The decoding processing unit 111 is the same as the decoding processing unit 202 (see FIG. 1) of the image processing apparatus 200 on the receiver side and carries out a compression decoding process on the encoded data A2 to obtain the image data A6′.

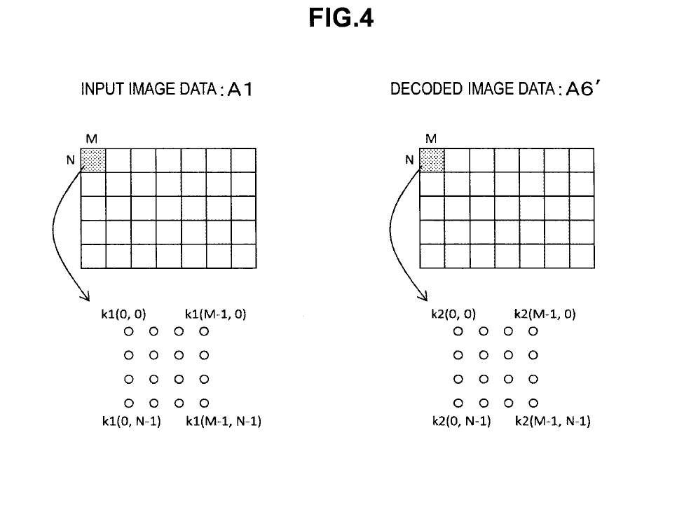

The activity calculating unit 112 generates information relating to the difference between spatial activity B1 of the input image data A1 and spatial activity B2 of the decoded image data A6′ as the additional information A4. That is, as shown in FIG. 4, the activity calculating unit 112 divides the input image data A1 and the decoded image data A6′ respectively into blocks of M horizontal pixels and N vertical pixels and calculates the spatial activities B1 and B2 for each block.

The spatial activity B1 of the input image data A1 is expressed by Equation (1).

$$\begin{matrix} Math 1 & \\ B 1 = {\sum }_{j = 0}^{N - 1} {\sum }_{i = 0}^{M - 2} {( k 1 ( i , j ) - k 1 ( i + 1 , j ) )}^{2} + {\sum }_{j = 0}^{N - 2} {\sum }_{i = 0}^{M - 1} {( k 1 ( i , j ) - k 1 ( i , j + 1 ) )}^{2} & ( 1 )\end{matrix}$$

The spatial activity B2 of the decoded image data A6′ is expressed by Equation (2).

$$\begin{matrix} Math 2 & \\ B 2 = {\sum }_{j = 0}^{N - 1} {\sum }_{i = 0}^{M - 2} {( k 2 ( i , j ) - k 2 ( i + 1 , j ) )}^{2} + {\sum }_{j = 0}^{N - 2} {\sum }_{i = 0}^{M - 1} {( k 2 ( i , j ) - k 2 ( i , j + 1 ) )}^{2} & ( 2 )\end{matrix}$$

Here, the spatial activities B1, B2 show the magnitudes of changes in the pixel values inside blocks in the input image data A1 and the decoded image data A6′, respectively. It is possible to conclude that high frequency information has been lost due to the encoding if B1>B2 and that tone information has been lost due to the encoding if B1<B2. As examples, the activity calculating unit 112 may output the difference B1−B2 without amendment as the additional information A4 of each block or may use the thresholds TH1, TH2, TH3 for reducing the data amount to decide and output the additional information A4 as shown in Equation (3).

$$\begin{matrix}Math 3 & \\ A 4 = \{ \begin{matrix}0 & When B 1 - B 2 > TH 1 \\ 1 & When TH 1 ≧ B 1 - B 2 > TH 2 \\ 2 & When TH 2 ≧ B 1 - B 2 > TH 3 \\ 3 & When TH 3 ≧ B 1 - B 2\end{matrix} & ( 3 )\end{matrix}$$

Next, the operation of the additional information generating unit 102 shown in FIG. 3 will be described. The encoded data A2 obtained by the encoding processing unit 101 is supplied to the decoding processing unit 111. In the decoding processing unit 111, a compression decoding process is carried out on the encoded data A2 to obtain the image data A6′. The image data A6′ is supplied to the activity calculating unit 112.

The input image data A1 is also supplied to the activity calculating unit 112. In the activity calculating unit 112, the spatial activity B1 of the input image data A1 and the spatial activity B2 of the decoded image data A6′ is calculated for each block. After this, the activity calculating unit 112 calculates information relating to the difference between the activities B1, B2 for each block. Next, information relating to such differences, for example B1−B2, or the information in Equation (3) given above is supplied as the additional information A4 from the activity calculating unit 112 to the encoded data/additional information mixing unit 103.

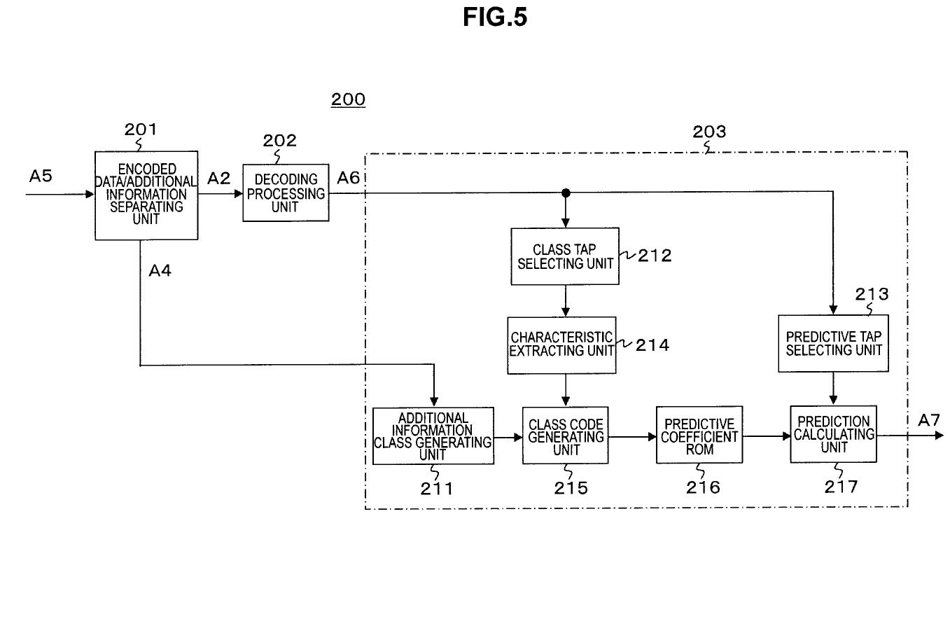

FIG. 5 shows an example configuration of the image quality enhancing processing unit 203. This example configuration is an example where image quality is improved by applying known class-classification adaptive processing to the image data after decoding. The image quality enhancing processing unit 203 includes an additional information class generating unit 211, a class tap selecting unit 212, a prediction tap selecting unit 213, a characteristic extracting unit 214, a class code generating unit 215, a prediction coefficient ROM 216, and a prediction calculating unit 217.

The additional information class generating unit 211 generates an additional information class based on the additional information A4 separated from the encoded data/additional information separating unit 201. As one example, the additional information class is one of four or more types classified using the thresholds TH1, TH2, and TH3 as shown in Equation (3) given above.

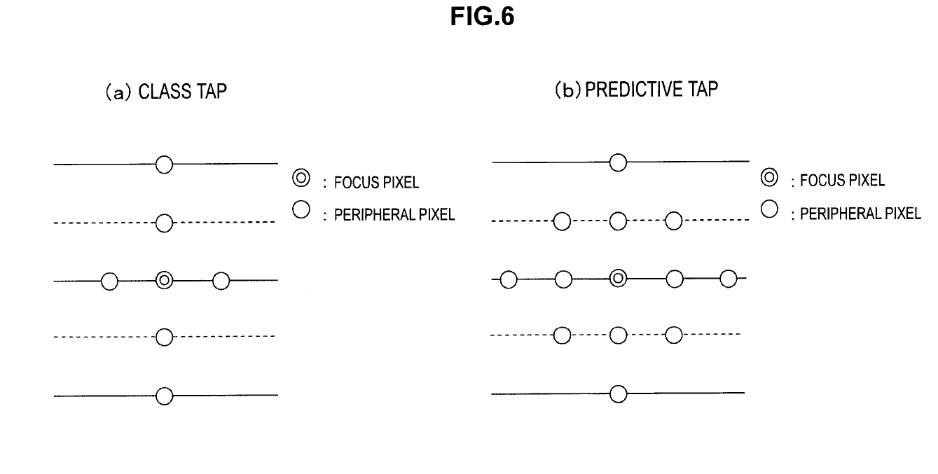

The class tap selecting unit 212 selectively extracts, from the image data A6 obtained by the decoding processing unit 202, a plurality of pixel data positioned in a periphery of a focus position in the output image data A7 as data of a class tap. FIG. 6A shows an example pattern of the plurality of pixel data extracted as the data of a class tap. In this example pattern, the class tap is set using a total of seven pixels composed of the focus pixel and a plurality of pixels in the periphery.

The prediction tap selecting unit 213 selectively extracts, from the image data A6 obtained by the decoding processing unit 202, a plurality of pixel data positioned in a periphery of a focus position of the output image data A7 as data of a prediction tap. FIG. 6B shows an example pattern of the plurality of pixel data extracted as the data of a prediction tap. In this example pattern, a prediction tap is set using a total of thirteen pixels composed of the focus pixel and a plurality of pixels in the periphery. Note that in FIGS. 6A and 6B, the solid lines show a first field and the broken lines show a second field.

The characteristic extracting unit 214 carries out a data compression process on the plurality of pixel data as the data of a class tap extracted by the class tap selecting unit 212 to generate compressed code. In the present embodiment, the characteristic extracting unit 214 carries out a one-bit ADRC (Adaptive Dynamic Range Coding) process to generate ADRC codes. ADRC finds maximum and minimum values of pixel values in the class tap, calculates the dynamic range that is the difference between the maximum and minimum values, and carries out requantization of the respective pixel values in keeping with the dynamic range. With one-bit ADRC, pixel values are converted to one-bit values showing whether a pixel value is larger than or smaller than the average value of the plurality of pixel values in the tap.

The class code generating unit 215 generates class codes showing the result of class-classification based on the additional information class generated by the additional information class generating unit 211 and the ADRC codes extracted by the characteristic extracting unit 214. The prediction coefficient ROM 216 outputs a prediction coefficient set corresponding to the class codes generated by the class code generating unit 215. The prediction coefficient set is decided in advance by a learning process, described later, and is stored in the prediction coefficient ROM 216 for each class with the class code as the address.

The prediction calculating unit 217 uses the plurality of pixel data xᵢ as the data of the prediction tap extracted by the prediction tap selecting unit 213, and coefficient data wᵢ to calculate pixel data y at the focus position in the output image data A7 based on an estimating formula such as that shown in Equation (4).

y=w₁×x₁+w₂×x₂+ . . . +wₙ×xₙ (4)

The operation of the image quality enhancing processing unit 203 shown in FIG. 5 will now be described. The additional information A4 separated by the encoded data/additional information separating unit 201 is supplied to the additional information class generating unit 211. In the additional information class generating unit 211, an additional information class is generated based on the additional information A4. The additional information class is supplied to the class code generating unit 215.

The image data A6 obtained by the decoding processing unit 202 is supplied to the class tap selecting unit 212. The class tap selecting unit 212 selectively extracts, from the image data A6, a plurality of pixel data positioned in the periphery of a focus position in the output image data A7 as data of a class tap. The data of the class tap is supplied to the characteristic extracting unit 214.

The characteristic extracting unit 214 carries out a one-bit ADRC process on the plurality of pixel data as the data of a class tap to generate ADRC codes. The ADRC codes are supplied to the class code generating unit 215. The class code generating unit 215 generates a class code that shows the result of classification into a class based on the additional information class generated by the additional information class generating unit 211 and the ADRC codes extracted by the characteristic extracting unit 214.

The class code generated in this way by the class code generating unit 215 is supplied to the prediction coefficient ROM 216 as an address. After this, a prediction coefficient set corresponding to the class code is outputted from the prediction coefficient ROM 216. This prediction coefficient set is supplied to the prediction calculating unit 217.

The image data A6 obtained by the decoding processing unit 202 is also supplied to the prediction tap selecting unit 213. In the prediction tap selecting unit 213, a plurality of pixel data positioned in the periphery of a focus position in the output image data A7 is selectively extracted from the image data A6 as data on a prediction tap. The data on a prediction tap is then supplied to the prediction calculating unit 217.

In the prediction calculating unit 217, based on an estimating formula such as that shown in Equation (4) for example, a plurality of pixel data xᵢ as the data on a prediction tap and the coefficient data wᵢ are used to find the pixel data y of the focus position in the output image data A7. In the image quality enhancing processing unit 203, by successively changing the focus position described earlier, pixel data of every position in the output image data A7 is calculated.

In the image quality enhancing processing unit 203 shown in FIG. 5, the addition information class differs according to whether the additional information A4 shows that high frequency information has been lost due to the compression encoding process or whether the additional information A4 shows that tone information has been lost due to the compression encoding process. For this reason, the prediction coefficient set outputted from the prediction coefficient ROM 216 is used to carry out processing that recovers the information lost from the image data A6 obtained by the decoding processing unit 202.

That is, if image data A6 where the high frequency information has been lost is obtained from the decoding processing unit 202, a prediction coefficient set for carrying out a sharpening process that recovers the lost high frequency information is outputted from the prediction coefficient ROM 216. Accordingly, in this case, the output image data A7 outputted from the prediction calculating unit 217 is data produced by carrying out a sharpening process on the image data A6.

Meanwhile, if image data A6 where the tone information has been lost is obtained from the decoding processing unit 202, a prediction coefficient set for carrying out a contrast correction process (smoothing process) that recovers the lost tone information is outputted from the prediction coefficient ROM 216. Accordingly, in this case, the output image data A7 outputted from the prediction calculating unit 217 is data produced by carrying out a contrast correction process on the image data A6.

Next, learning, or in other words the processing that calculates a prediction coefficient set for each class, will be described. In this case, a prediction coefficient set is calculated by carrying out specified processing based on image data (master data) corresponding to the image data to be predicted by class-classification adaptive processing and image data (study data) obtained by carrying out encoding and decoding processes on the master data. Here, the master data is the image data before high-frequency information, tone information, or the like is lost due to the compression encoding process. Also, the study data is image data after high-frequency information, tone information, or the like has been lost due to the compression encoding process.

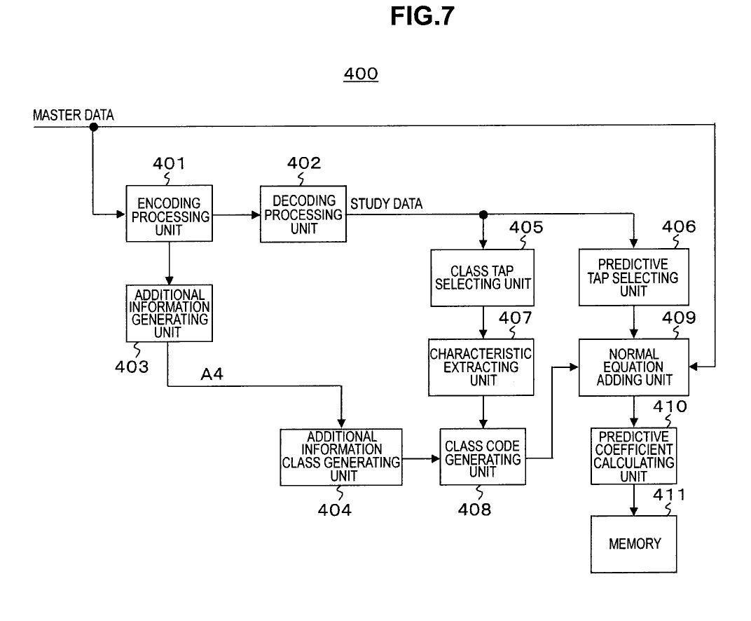

FIG. 7 shows an example configuration of a prediction coefficient set generating apparatus 400. The prediction coefficient set generating apparatus 400 includes an encoding processing unit 401, an additional information generating unit 403, and a decoding processing unit 402. The prediction coefficient set generating apparatus 400 also includes an additional information class generating unit 404, a class tap selecting unit 405, a prediction tap selecting unit 406, and a characteristic extracting unit 407. The prediction coefficient set generating apparatus 400 further includes a class code generating unit 408, a normal equation adding unit 409, a prediction coefficient calculating unit 410, and a memory 411.

The encoding processing unit 401 obtains encoded data by carrying out a compression encoding process on the master data using an encoding technique such as MPEG2. The encoded data includes accompanying information (decoding additional information) required in the decoding process. The encoding processing unit 401 corresponds to the encoding processing unit 101 (see FIGS. 1, 3) of the image processing apparatus 100 described earlier. The decoding processing unit 402 carries out a compression decoding process on the encoded data obtained by the encoding processing unit 401 to obtain image data as the study data. The decoding processing unit 402 corresponds to the decoding processing unit 202 (see FIGS. 1, 5) of the image processing apparatus 200 described earlier.

The additional information generating unit 403 generates the additional information A4 based on additional information generating information related to the master data supplied from the encoding processing unit 401. The additional information generating unit 403 is configured in the same way as the additional information generating unit 102 shown in FIG. 3 described earlier and generates, as the additional information A4, information showing whether high-frequency information has been lost or tone information has been lost due to the compression encoding process. That is, the additional information generating unit 403 generates, as the additional information A4, information relating to the difference between the spatial activity B1 of the master data and the spatial activity B2 of image data obtained by carrying out a compression decoding process on the encoded data.

The additional information class generating unit 404 generates the additional information class based on the additional information A4 generated by the additional information generating unit 403. For example, the additional information class is one of four or more types classified using the thresholds TH1, TH2, and TH3 as shown in Equation (3) described earlier. The additional information class generating unit 404 corresponds to the additional information class generating unit 211 (see FIG. 5) of the image quality enhancing processing unit 203 described earlier.

The class tap selecting unit 405 selectively extracts, from the study data obtained by the decoding processing unit 402, a plurality of pixel data positioned in the periphery of a focus position in the master data as data on a class tap. The prediction tap selecting unit 406 selectively extracts, from the study data obtained by the decoding processing unit 402, a plurality of pixel data positioned in the periphery of a focus position in the master data as data on a prediction tap. These tap selecting units 405, 406 respectively correspond to the tap selecting units 212, 213 of the image quality enhancing processing unit 203 described earlier.

The characteristic extracting unit 407 carries out a one-bit ADRC process on the plurality of pixel data as the data on a class tap extracted by the class tap selecting unit 405 to generate ADRC codes. The characteristic extracting unit 407 corresponds to the characteristic extracting unit 214 (see FIG. 5) of the image quality enhancing processing unit 203 described earlier.

The class code generating unit 408 generates a class code showing the result of classification into a class based on the additional information class generated by the additional information class generating unit 404 and the ADRC codes extracted by the characteristic extracting unit 407. The class code generating unit 408 corresponds to the class code generating unit 215 (see FIG. 5) of the image quality enhancing processing unit 203 described earlier.

The normal equation adding unit 409 carries out a specified calculation process based on the data of the prediction tap extracted by the prediction tap selecting unit 406 and the master data to generate data of a normal equation that has the prediction coefficient set corresponding to the class code supplied from the class code generating unit 408 as a solution. The prediction coefficient calculating unit 410 carries out a calculation process for solving a normal equation based on the data of the normal equation generated by the normal equation adding unit 409. The memory 411 stores the prediction coefficient sets of the respective class codes calculated by the prediction coefficient calculating unit 410. The stored content of the memory 411 is loaded into the prediction coefficient ROM 216 of the image quality enhancing processing unit 203 shown in FIG. 5 described earlier.

The normal equation will now be described. In Equation (4) described above, before learning, the prediction coefficient set w₁, . . . , wₙ are all undefined coefficients. Learning is carried out by inputting a plurality of master data for each class. If the number of types of master data is expressed as m, Equation (5) is set from Equation (4).

yₖ=w₁×xₖ₁+w₂×xₖ₂+ . . . +wₙ×xₖₙ (where k=1,2, . . . , m) (5)

Since the prediction coefficients w₁, . . . , wₙ are not uniquely decided when m>n, the element eₖ of the error vector e is defined by Equation (6) below and the prediction coefficient set is decided so as to minimize the error vector e defined by Equation (7). That is, the prediction coefficient set is uniquely decided by a so-called least squares method.

$$\begin{matrix}Math 4 & \\ {e}_{k} = {y}_{k} - \{ {w}_{1} \times {x}_{k 1} + {w}_{2} \times {x}_{k 2} + … + {w}_{n} \times {x}_{kn} \} \\ ( where k = 1 , 2 , … , m ) & ( 6 ) \\ {e}^{2} = {\sum }_{k = 0}^{m} {e}_{k}^{2} & ( 7 )\end{matrix}$$

As an actual calculation method for calculating the prediction coefficient set that minimizes e² in Equation (7), as shown in Equation (8) it is possible to partially differentiate e² for the prediction coefficients wᵢ (i=1, 2, . . . ) and to decide the respective prediction coefficients wᵢ so that the partial differential for each value of i is zero.

$$\begin{matrix}Math 5 & \\ \frac{\partial {e}^{2}}{\partial {w}_{i}} = {\sum }_{k = 0}^{m} 2 ( \frac{\partial {e}_{k}}{\partial {w}_{i}} ) {e}_{k} = {\sum }_{k = 0}^{m} 2 {x}_{ki} \cdot {e}_{k} & ( 8 )\end{matrix}$$

The specific procedure for deciding the respective prediction coefficients wᵢ from Equation (8) will now be described. If Xⱼᵢ, Yᵢ are defined by Equation (9) and Equation (10), Equation (8) can be written in the form of the determinant in Equation (11).

$$\begin{matrix}Math 6 & \\ {X}_{ji} = {\sum }_{p = 0}^{m} {x}_{π} \cdot {x}_{pj} & ( 9 ) \\ Math 7 & \\ {Y}_{i} = {\sum }_{k = 0} {x}_{ki} \cdot {y}_{k} & ( 10 ) \\ Math 8 & \\ [ \begin{matrix}{X}_{11} & {X}_{12} & … & {X}_{1 n} \\ {X}_{21} & {X}_{22} & … & {X}_{2 n} \\ … & … & … & … \\ {X}_{m 1} & {X}_{m 2} & … & {X}_{mn}\end{matrix} ] [ \begin{matrix}{W}_{1} \\ {W}_{2} \\ … \\ {W}_{n}\end{matrix} ] = [ \begin{matrix}{Y}_{1} \\ {Y}_{2} \\ … \\ {Y}_{m}\end{matrix} ] & ( 11 )\end{matrix}$$

Equation (11) is what is typically referred to as a normal equation. The prediction coefficient calculating unit 410 carries out calculation processing according to typical matrix calculus, such as sweeping out, to solve the normal equation in Equation (11) to calculate the prediction coefficients wᵢ.

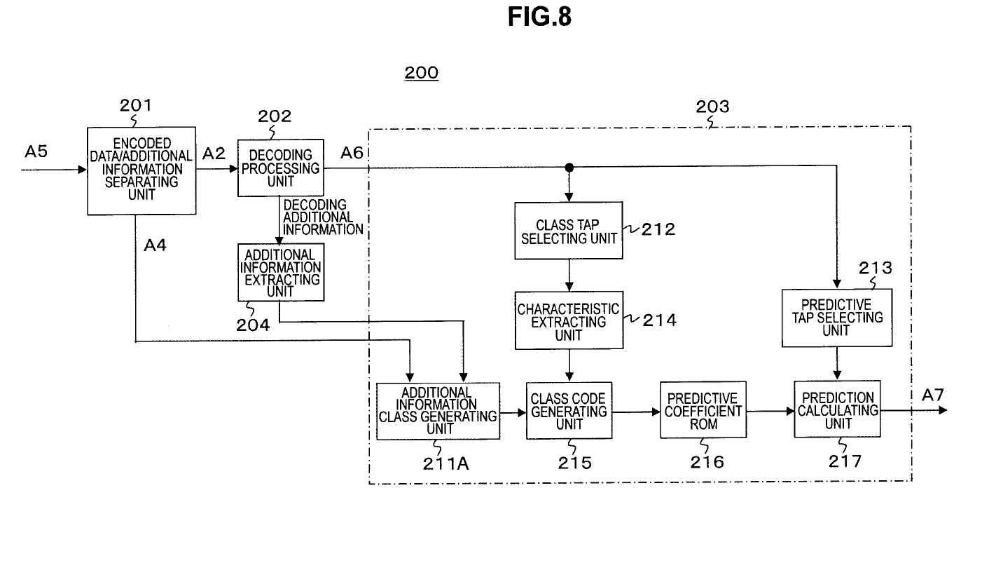

FIG. 8 shows another example configuration of the image quality enhancing processing unit 203. This example configuration is an example where image quality is enhanced by using known class-classification adaptive processing on image data after decoding. In FIG. 8, parts that correspond to FIG. 5 have been assigned the same reference numerals and detailed description thereof is omitted. This image quality enhancing processing unit 203 includes an additional information class generating unit 211A, the class tap selecting unit 212, the prediction tap selecting unit 213, the class code generating unit 215, the prediction coefficient ROM 216, and the prediction calculating unit 217.

The additional information class generating unit 211A generates an additional information class based on the additional information A4 separated by the encoded data/additional information separating unit 201 and the additional information extracted by an additional information extracting unit 204. The additional information extracting unit 204 selectively outputs additional information to be used in the class-classification adaptive processing from the decoding additional information (i.e., the accompanying information required by the decoding process) outputted from the decoding processing unit 202.

The class code generating unit 215 generates a class code showing the result of classification into a class based on the additional information class generated by the additional information class generating unit 211A and the ADRC codes extracted by the characteristic extracting unit 214. The prediction coefficient ROM 216 outputs the prediction coefficient set corresponding to the class code generated by the class code generating unit 215.

The rest of the image quality enhancing processing unit 203 shown in FIG. 8 is configured in the same way as the image quality enhancing processing unit 203 shown in FIG. 5 and operates in the same way. That is, with the image quality enhancing processing unit 203 shown in FIG. 8, the additional information class differs between a case where the additional information A4 shows that high-frequency information has been lost due to the compression encoding process and a case where the additional information A4 shows that tone information has been lost due to the compression encoding process.

This means the prediction coefficient set outputted from the prediction coefficient ROM 216 is information for carrying out a process that recovers the information lost from the image data A6 obtained by the decoding processing unit 202. That is, in the image quality enhancing processing unit 203, a sharpening process or a contrast correction process is adaptively carried out on the image data A6 to favorably enhance the image quality.

The image quality enhancing processing unit 203 shown in FIG. 8 is also configured to refer to the additional information A4 and also the additional information selected by the additional information extracting unit 204 from the decoding additional information when the additional information class is generated in the additional information class generating unit 211A. This means that it is possible to improve the prediction precision of the class-classification adaptive processing and to carry out the image quality enhancing process even more favorably.

The image quality enhancing processing unit 203 shown in FIG. 8 is also configured to refer to the additional information A4 and also the additional information selected by the image quality enhancing processing unit 203 from the decoding additional information when generating the additional information class in the additional information class generating unit 211A. This means that it is possible to improve the prediction precision of the class-classification adaptive processing and to enhance the image quality even more favorably.

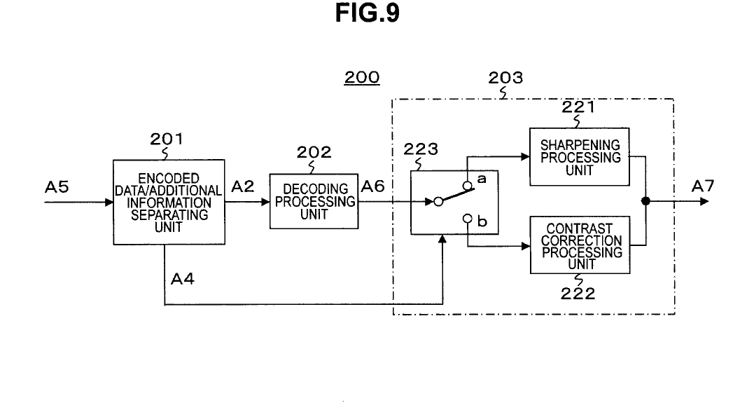

FIG. 9 shows another example configuration of the image quality enhancing processing unit 203. This image quality enhancing processing unit 203 includes a sharpening processing unit 221, a contrast correction processing unit (smoothing processing unit) 222, and a switch 223.

The sharpening processing unit 221 carries out a sharpening process on the image data A6 obtained by the decoding processing unit 202 to obtain the output image data A7. The contrast correction processing unit (smoothing processing unit) 222 carries out a contrast correction process (smoothing process) on the image data A6 obtained by the decoding processing unit 202 to obtain the output image data A7. The switch 223 selectively supplies the image data A6 obtained by the decoding processing unit 202 to the sharpening processing unit 221 or the contrast correction processing unit 222.

Switching of the switch 223 is controlled based on the additional information A4 separated by the encoded data/additional information separating unit 201. That is, if the additional information A4 shows that high-frequency information has been lost due to the compression encoding process, the a side is connected and the image data A6 obtained by the decoding processing unit 202 is supplied to the sharpening processing unit 221. Meanwhile, if the additional information A4 shows that tone information has been lost due to the compression encoding process, the b side is connected and the image data A6 obtained by the decoding processing unit 202 is supplied to the contrast correction processing unit (smoothing processing unit) 222.

The operation of the image quality enhancing processing unit 203 shown in FIG. 9 will now be described. The additional information A4 separated by the encoded data/additional information separating unit 201 is supplied as a switching control signal to the switch 223. If the additional information A4 shows that high-frequency information has been lost due to the compression encoding process, the switch 223 is connected to the a side. Meanwhile, if the additional information A4 shows that tone information has been lost due to the compression encoding process, the switch 223 is connected to the b side.

For this reason, if image data A6 where the high-frequency information has been lost is obtained from the decoding processing unit 202, such image data A6 is supplied via the switch 223 to the sharpening processing unit 221. In the sharpening processing unit 221, a sharpening process is carried out on the image data A6. Accordingly, in this case, the output image data A7 outputted from the image quality enhancing processing unit 203 is data produced by carrying out a sharpening process on the image data A6 and has improved image quality.

Also, if image data A6 where the tone information has been lost is obtained from the decoding processing unit 202, such image data A6 is supplied via the switch 223 to the contrast correction processing unit 222. In the contrast correction processing unit 222, a contrast correction process (smoothing process) is carried out on the image data A6. Accordingly, in this case, the output image data A7 outputted from the image quality enhancing processing unit 203 is data produced by carrying out a contrast correction process (smoothing process) on the image data A6 and has improved image quality.

### (2) When the Image Quality Enhancing Process is a Noise Reduction Process

Next, the case where the image quality enhancing process is a noise reduction process will be described. It is typical for data deterioration, that is, noise to be caused by a compression encoding process. When noise reduction is carried out in the image quality enhancing process, it is effective to use the size of the deterioration as a parameter in the noise reduction process. By comparing the image data before and after encoding, the size of the deterioration due to the compression encoding process is known. Since it is not possible to know the size of the deterioration from the decoded image data itself, during decoding it is not possible to recreate such information.

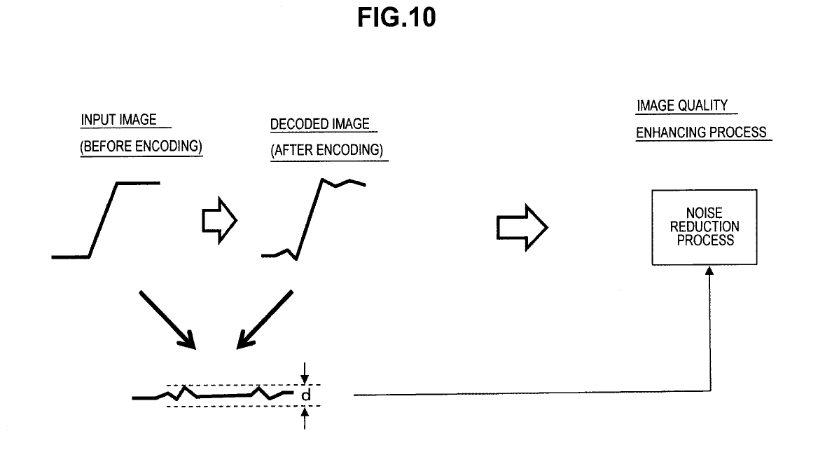

For example, as shown in FIG. 10, if the decoded image data has deteriorated relative to the input image data, that is, if noise has been produced, it would be desirable to carry out a noise reduction process as the image quality enhancing process. In this case, it is effective to use the size of the deterioration (the size of the noise) d as a parameter of the noise reduction process. Note that in FIG. 10, a case is shown where the size of the deterioration is the maximum absolute value of the difference before and after encoding.

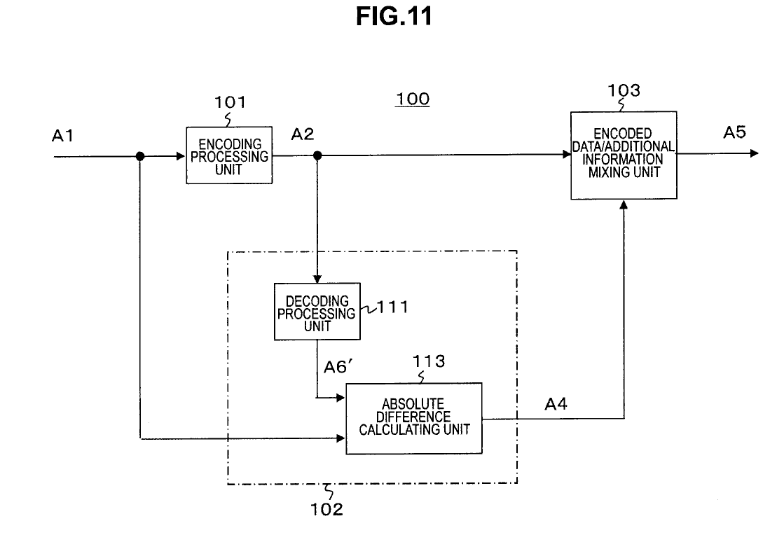

FIG. 11 shows an example configuration of the additional information generating unit 102. The additional information generating unit 102 includes a decoding processing unit 111 and an absolute difference calculating unit 113. The decoding processing unit 111 is the same as the decoding processing unit 202 (see FIG. 1) of the image processing apparatus 200 on the receiver side and carries out a compression encoding process on the encoded data A2 to obtain the image data A6′.

The absolute difference calculating unit 113 generates information on the maximum value of the absolute difference between the input image data A1 and the decoded image data A6′ as the additional information A4. That is, as shown in FIG. 4 described earlier, the absolute difference calculating unit 113 divides the input image data A1 and the decoded image data A6′ respectively into blocks with horizontal M pixels and the vertical N pixels. After this, the absolute difference calculating unit 113 finds the maximum absolute difference which is the intra-block maximum of the absolute difference between pixel values at the same position in A1 and A6′.

The maximum absolute difference is expressed by Equation (12).

Math 9

Maximum absolute difference=max(|k1(0,0)−k2(0,0)|,|k1(0,1)−k2(0,1)|, . . . , |k1(M−1,N−1)−k2(M−1,N−1)|) (12)

The maximum absolute difference is an intra-block maximum of the deterioration (noise) produced by the encoding processing unit 101. The absolute difference calculating unit 113 outputs the maximum absolute difference as the additional information A4 for each block.

The operation of the additional information generating unit 102 shown in FIG. 11 will now be described. The encoded data A2 obtained by the encoding processing unit 101 is supplied to the decoding processing unit 111. In the decoding processing unit 111, a compression decoding process is carried out on the encoded data A2 and the image data A6′ is obtained. This image data A6′ is supplied to the absolute difference calculating unit 113.

The input image data A1 is also supplied to the absolute difference calculating unit 113. In the absolute difference calculating unit 113, the intra-block maximum value of the absolute difference between the pixel values at the same position in the input image data A1 and the image data A6′ is calculated for each block. After this, the maximum absolute difference is supplied from the absolute difference calculating unit 113 to the encoded data/additional information mixing unit 103 as the additional information A4.

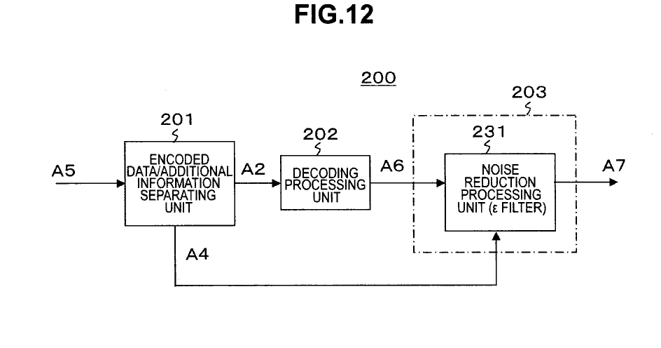

FIG. 12 shows an example configuration of the image quality enhancing processing unit 203. This example configuration is an example where a noise reduction process is carried out on the image data after decoding. The image quality enhancing processing unit 203 includes a noise reduction processing unit 231. The noise reduction processing unit 231 carries out a noise reduction process on the image data A6 obtained by the decoding processing unit 202 using a known e (upsilon) filter to obtain the output image data A7. The noise reduction processing unit 231 sets the additional information A4 separated by the encoded data/additional information separating unit 201 as the value of ε.

The operation of the image quality enhancing processing unit 203 shown in FIG. 12 will now be described. The additional information A4 separated by the encoded data/additional information separating unit 201 is supplied to the noise reduction processing unit 231 as the value of ε. After this, in the noise reduction processing unit 231, a noise reduction process is carried out on the image data A6 obtained by the decoding processing unit 202 using a ε filter to obtain the output image data A7 after noise reduction.

In the ε filter, the parameter ε shows an assumed maximum value of the noise. Since the ε value is set at the additional information A4, that is, the maximum deterioration in a block, effective noise reduction is carried out by the noise reduction processing unit 231.

### 2. Second Embodiment

### Configuration of Image Transfer System

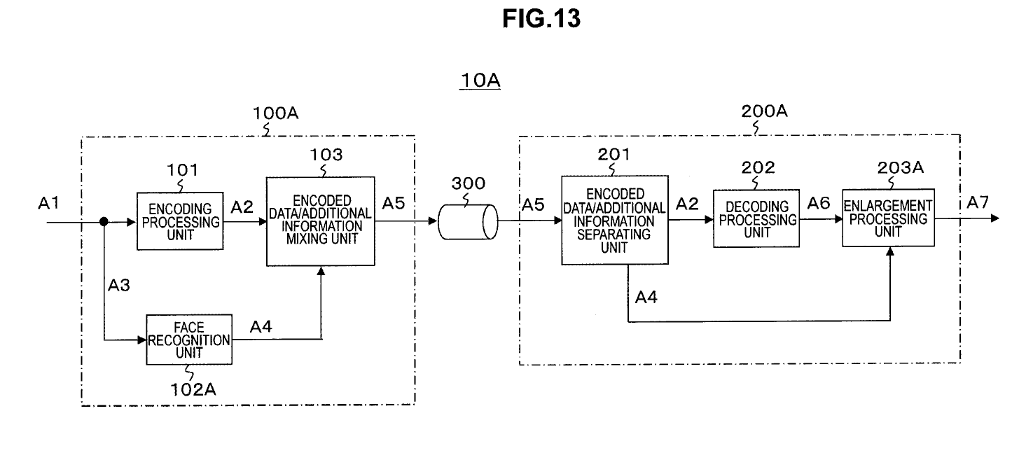

FIG. 13 shows the example configuration of an image transfer system 10A as a second embodiment of the present disclosure. The image transfer system 10A is configured by connecting an image processing apparatus 100A on a transmitter side (recording side) and an image processing apparatus 200A on a receiver side (reproduction side) via a transfer path 300. The “transfer path 300” includes a communication path, such as a network, and a recording/reproduction unit, such as a recording medium like an optical disc or a memory. In FIG. 13, parts that correspond to FIG. 1 have been assigned the same reference numerals and detailed description thereof is omitted as appropriate.

The image processing apparatus 100A includes the encoding processing unit 101, a face recognition unit 102A, and the encoded data/additional information mixing unit 103. The encoded data/additional information mixing unit 103 constructs a “data output unit” for the present disclosure. The face recognition unit 102A constructs an “additional information generating unit” for the present disclosure. The encoding processing unit 101 carries out a compression encoding process according to an encoding technique such as MPEG2 on input image data A1 to obtain encoded data A2. The encoded data A2 includes accompanying information (decoding additional information) that is required for a decoding process.

The face recognition unit 102A inputs the input image data A1 as the additional information generating information A3. The face recognition unit 102A carries out a known face recognition process on the input image data A1 to detect faces included in the input image and outputs coordinate data of a face region as the additional information A4.

The encoded data/additional information mixing unit 103 mixes the additional information A4 generated by the face recognition unit 102A into the encoded data A2 obtained by the encoding processing unit 101 to obtain the mixed data A5. The mixed data A5 constructs the “transfer data” and is sent via the transfer path 300 to the image processing apparatus 200A on the receiver side.

The image processing apparatus 200A includes the encoded data/additional information separating unit 201, the decoding processing unit 202, and an enlargement processing unit 203A. The encoded data/additional information separating unit 201 separates the encoded data A2 and the additional information A4 from the mixed data A5. The decoding processing unit 202 carries out a compression decoding process on the encoded data A2 separated by the encoded data/additional information separating unit 201 to obtain the image data A6.

Using the additional information A4 separated by the encoded data/additional information separating unit 201, that is, the coordinate data of the face region, the enlargement processing unit 203A processes the image data A6 obtained by the decoding processing unit 202 to enlarge the face region and outputs the output image data A7. As the enlarging method, the enlargement processing unit 203A may use a known technique such as bicubic interpolation.

The operation of the image transfer system 10A shown in FIG. 13 will now be described in brief. First, the operation of the image processing apparatus 100A on the transmitter side will be described. The input image data A1 is supplied to the encoding processing unit 101. In the encoding processing unit 101, the input image data A1 is subjected to a compression encoding process using an encoding technique such as MPEG2 to obtain the encoded data A2. This encoded data A2 is supplied to the encoded data/additional information mixing unit 103.

The input image data A1 is also supplied to the face recognition unit 102A. In the face recognition unit 102A, a known face recognition process is carried out on the input image data A1 to detect faces included in the input image and obtain coordinate data of a face region. After this, the coordinate data of the face region is supplied from the face recognition unit 102A to the additional information generating unit 102 as the additional information A4.

In the encoded data/additional information mixing unit 103, the additional information A4 is mixed into the encoded data A2 to obtain the mixed data A5. The mixed data A5 is sent via the transfer path 300 to the image processing apparatus 200A on the receiver side.

Next, the operation of the image processing apparatus 200A on the receiver side will be described. The mixed data A5 is supplied to the encoded data/additional information separating unit 201. In the encoded data/additional information separating unit 201, the encoded data A2 and the additional information A4 are separated from the mixed data A5. The encoded data A2 is supplied to the decoding processing unit 202. The additional information A4 is supplied to the enlargement processing unit 203A.

In the decoding processing unit 202, a compression decoding process is carried out on the encoded data A2 to obtain the image data A6. When doing so, in the decoding processing unit 202, the decoding additional information included in the encoded data A2 is used. The image data A6 is supplied to the enlargement processing unit 203A. In the enlargement processing unit 203A, a process that enlarges the face region is carried out on the image data A6 obtained by the decoding processing unit 202 using the additional information A4 separated by the encoded data/additional information separating unit 201, that is, the coordinate data of the face region. After this, image data produced by the enlargement process is outputted from the enlargement processing unit 203A as the output image data A7.

In the image transfer system 10A shown in FIG. 13, at the enlargement processing unit 203A of the image processing apparatus 200A on the receiver side, coordinate data of the face region sent as the additional information A4 from the transmitter side is used to carry out an enlargement process on the face region. Here, it would be conceivable to carry out a face recognition process on the image data A6 obtained by the decoding processing unit 202 to detect faces and obtain coordinate data of the face region. However, there is the risk that it will not be possible to correctly detect faces from the image data A6 that has undergone encoding and decoding. That is, by using the additional information A4 that is the result of face detection on the input image data A1 before encoding, it is possible at the enlargement processing unit 203A to correctly enlarge the face region.

Note that in the image transfer system 10A shown in FIG. 13, enlargement of a face region is carried out by the enlargement processing unit 203A of the image processing apparatus 200A on the receiver side. In the same way, it is also possible to enlarge a region of a specified object included in an image. When doing so, a detection process may be carried out for the specified object at the image processing apparatus 100A on the transmitter side and coordinate data of the region of such specified object may be set as the additional information A4.

### 3. Modifications

Note that in the embodiments described above, an image quality enhancing process or an enlargement process is carried out on decoded image data at the image processing apparatus on the receiver side. However, it should be obvious that the present disclosure can be applied in the same way even when image processing aside from an image quality enhancing process or an enlargement process is carried out on decoded image data. In such case, information that is useful for the image processing carried out on the decoded image data at the receiver side may be generated as the additional information A4 at the image processing apparatus on the transmitter side and may be transmitted after being mixed with the encoded data A2. Another conceivable example of image processing is processing that increases spatial resolution and/or temporal resolution.

In the embodiments described above, configurations are described where the image processing apparatus on the transmitter side mixes the additional information A4 into the encoded data A2 to produce the mixed data A5 that is sent to the image processing apparatus on the receiver side. However, it is not necessary to mix the encoded data A2 and the additional information A4 and such data may be associated and outputted from the image processing apparatus on the transmitter side so as to be sent to the image processing apparatus on the receiver side. That is, the encoded data A2 and the additional information A4 may be transmitted via respectively different transfer paths.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-104035 filed in the Japan Patent Office on May 9, 2011, the entire content of which is hereby incorporated by reference.

What is claimed is:

1. An image processing apparatus comprising:
an encoding processing unit carrying out a compression encoding process on input image data to obtain encoded data;
an additional information generating unit generating, based on additional information generating information relating to the input image data, additional information to be used when specified image processing is carried out on image data obtained by carrying out a compression decoding process on the encoded data; and
a data output unit outputting the encoded data obtained by the encoding processing unit and the additional information generated by the additional information generating unit in association with one another.

2. An image processing apparatus according to claim 1,
wherein the specified image processing carried out on the image data obtained by carrying out the compression decoding process on the encoded data is an image quality enhancing process, and
the additional information generated by the additional information generating unit is information used when carrying out the image quality enhancing process.

3. An image processing apparatus according to claim 2,
wherein the image quality enhancing process is a sharpening process or a contrast correction process, and the additional information generating unit generates, as the additional information, information showing whether high-frequency information has been lost or tone information has been lost due to the compression encoding process.

4. An image processing apparatus according to claim 3,
wherein the additional information generating unit generates, as the additional information, information relating to a difference between spatial activity of the input image data and spatial activity of the image data obtained by carrying out the compression decoding process on the encoded data.

5. An image processing apparatus according to claim 2,
wherein the image quality enhancing process is a noise reduction process, and the additional information generating unit generates, as the additional information, information showing a size of deterioration produced in the compression encoding process.

6. An image processing apparatus according to claim 5,
wherein the additional information generating unit generates, as the additional information, information on a maximum value of an absolute difference between the input image data and the image data obtained by carrying out the compression decoding process on the encoded data.

7. An image processing apparatus according to claim 1,
wherein the specified image processing carried out on the image data obtained by carrying out the compression decoding process on the encoded data is an image enlargement process that enlarges a region of a specified object, and
the additional information generated by the additional information generating unit is region information of the specified object obtained by carrying out a detection process for the specified object based on the input image data.

8. An image processing apparatus according to claim 1,
wherein the data output unit outputs mixed data where the additional information generated by the additional information generating unit has been mixed into the encoded data obtained by the encoding processing unit.

9. An image processing method comprising:
carrying out a compression encoding process on input image data to obtain encoded data;
generating, based on additional information generating information relating to the input image data, additional information to be used when specified image processing is carried out on image data obtained by carrying out a compression decoding process on the encoded data; and
outputting the encoded data and the additional information in association with one another.

10. An image processing apparatus comprising:
a separating unit separating, from mixed data in which encoded data and additional information to be used when carrying out specified image processing on image data obtained by carrying out a compression decoding process on the encoded data are mixed, the encoded data and the additional information;
a decoding processing unit carrying out the compression decoding process on the encoded data separated by the separating unit to obtain the image data; and
an image processing unit carrying out the specified image processing on the image data obtained by the decoding processing unit using the additional information separated by the separating unit to obtain output image data.

11. An image processing method comprising:
separating, from mixed data in which encoded data and additional information to be used when carrying out specified image processing on image data obtained by carrying out a compression decoding process on the encoded data are mixed, the encoded data and the additional information;
carrying out the compression decoding process on the separated encoded data to obtain the image data; and
carrying out the specified image processing on the obtained image data using the separated additional information to obtain output image data.
